(19) United States
(12) Patent Application Publication
(10) Pub. No.: US 2018/0064602 A1
(43) Pub. Date: Mar. 8, 2018

(54) MASSAGE DEVICE

(71) Applicant: Neale D. Hare, Chesapeake, VA (US)

(72) Inventor: Neale D. Hare, Chesapeake, VA (US)

(21) Appl. No.: 15/694,006

(22) Filed: Sep. 1, 2017

Related U.S. Application Data
(60) Provisional application No. 62/384,755, filed on Sep. 8, 2016.

(51) Int. Cl. A61H 23/02

(52) U.S. Cl. CPC A61H 23/0263; A61H 2201/0161; A61H 2201/0153; A61H 2201/165

(57) ABSTRACT

A massage device for use by a person in massaging the body. The massage device may comprise an elongated strap terminating in loop handles and including a massager including a powered vibrator located between the loop handles. The powered vibrator includes an oscillatable mass which may be spring mounted to the powered vibrator, the powered vibrator and oscillatable mass are covered by a housing. Where covering the oscillatable mass, the housing is flexible and may be filled with a fluent gel material and solid beads. An opposed section of the housing is removable from the massager to provide access to a battery and the powered vibrator.

### RELATED APPLICATIONS

This application claims priority in accordance with 37 CF.R. ¶1.19(e) to U.S. Provisional Patent Application Ser. No. 62/384,755 filed for MASSAGE DEVICE, filed Sep. 8, 2016 which is included herein in its entirety by reference.

### FIELD OF THE DISCLOSURE

The present disclosure relates to massage implements, and more particularly, to a flexible, hand held massage implement usable by a person on his or her own body.

### BACKGROUND

Massage devices used by people for their own bodies are well known, and may include hand held straps and a textured or vibrating element between the two ends of a strap. The vibrating effect arising from a powered vibrator may be dissipated or otherwise diminished in strap type massage devices, if care is not taken to preserve the desired effect. There remains a need for an improved vibration type strap massage devices which provides desired sensory effect when in use.

### SUMMARY

The disclosed concepts address the above stated situation by providing a strap type massage device having a relatively large oscillatable mass coupled to the vibrator by springs. The vibrator is electrically operated, and powered from a battery integral with the massage device. The electrical components and oscillatable mass are enclosed within a housing. The housing may have a fluent gel layer with solid beads therein, to modify sensory effect at the skin.

It is an object to provide improved elements and arrangements thereof by apparatus for the purposes described which is inexpensive, dependable, and fully effective in accomplishing its intended purposes.

### BRIEF DESCRIPTION OF THE DRAWINGS

Various objects, features, and attendant advantages of the disclosed concepts will become more fully appreciated as the same becomes better understood when considered in conjunction with the accompanying drawings, in which like reference characters designate the same or similar parts throughout the several views, and wherein:

FIG. 1 is an environmental view of a massage device and a user thereof, according to at least one aspect of the disclosure;

FIG. 2 is an enlarged cross sectional detail taken along line 2-2 in FIG. 1; and

FIG. 3 is an enlarged plan view of the center of the massage device of FIG. 1, showing an optional variation on the massage device of FIG. 1.

### DETAILED DESCRIPTION

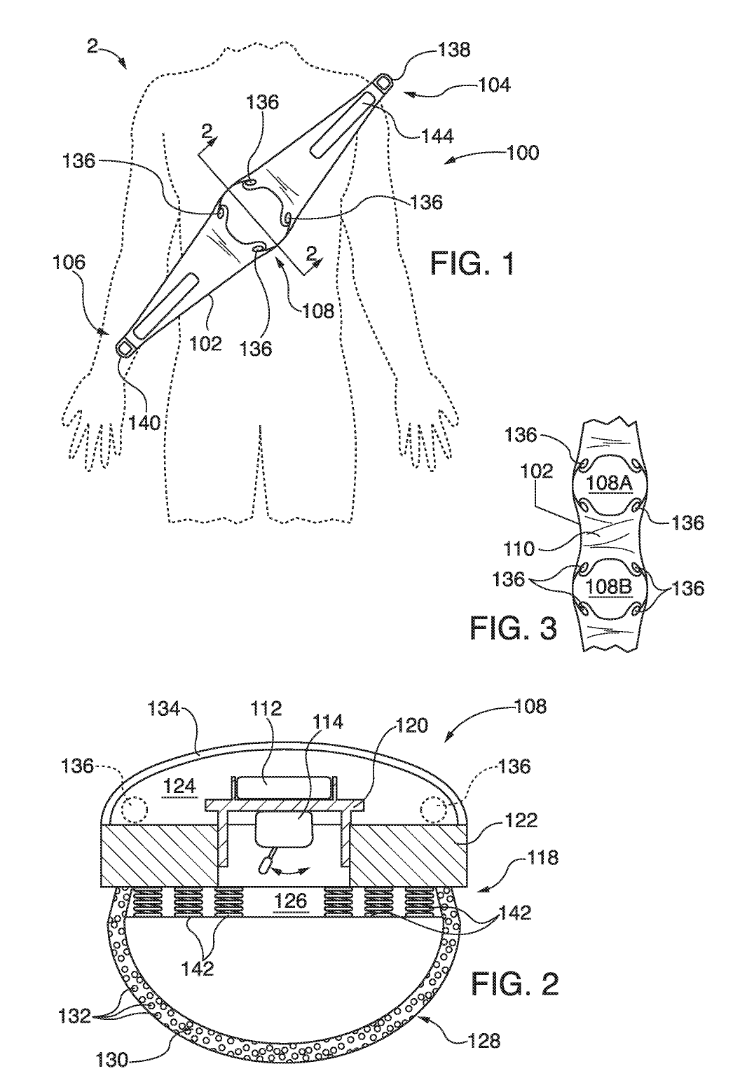

Referring first to FIG. 1, according to at least one aspect of the disclosure, there is shown a massage device 100 for enabling a user 2 to massage his or her body. Massage device 100 may comprise an elongated strap 102 including a proximal end 104 and a distal end 106. A massager 108 is coupled to elongated strap 102, massager 108 including a liquid resistant housing 110, a battery 112 within liquid resistant housing 110, an electrically powered vibrator 114 within liquid resistant housing 110, an oscillatable mass 116 within liquid resistant housing 110, and a spring coupling 118 between and coupled to oscillatable mass 116 and electrically powered vibrator 114. Oscillatable mass may comprise a metallic bar for example. Spring coupling 118 may comprise several individual springs 142 (e.g., as shown in FIG. 2), or may comprise a different number of springs 142 or only one spring 142 (this option is not shown).

In one implementation of massage device 100, that shown in FIG. 2, battery 112 and electrically powered vibrator 114 are coupled to a support frame 120 which support frame 120 is in turn anchored to a plate 122. Plate 122 divides liquid resistant housing 110 into a first chamber 124 containing battery 112 and vibrator 114, and a second chamber 126 containing oscillatable mass 116. Liquid resistant housing 110 may comprise a flexible section 128 covering oscillatable mass 116. Flexible section 128 of liquid resistant housing 110 may contain therein a fluent gel material 130 and solid beads 132. Solid beads 132 may be plastic, metal, ceramic, or of similarly rigid materials. Solid beads 132, surrounded by fluent gel material 130, may provide a kneading effect when electrically powered vibrator 114 is operating.

Unless otherwise indicated, the terms “first”, “second”, etc., are used herein merely as labels, and are not intended to impose ordinal, positional, or hierarchical requirements on the times to which these terms refer. Moreover, reference to, e.g., a “second” item does not either require or preclude the existence of, e.g., a “first” or lower-numbered item, and/or, e.g., a “third” or higher-numbered item.

In the implementation of FIG. 2, liquid resistant housing 110 comprises flexible section 128 and a second section 134 covering first chamber 124. Massager 108 may comprise at least one fastener 136 removably fastening second section 134 in a position covering first chamber 124. This gives access to battery 112 and electrically powered vibrator 114, e.g., for service if needed.

Massage device 100 may further comprise at least a first handle 138 at proximal end 104 of elongated strap 102. First handle 138 may be configured as a closed loop. Massage device 100 may further comprise a second handle 140 at distal end 106 of elongated strap 102. Second handle 140 may be configured as a closed loop.

Overall configuration of massage device 100 enables massage device 100 to be grasped by hand at proximal and distal ends 104, 106 and drawn across the body reciprocatingly, when massage device 100 is fabricated to proportions illustrated in FIG. 1, which includes the body of user 2 to afford a sense of preferred scale. Grasp of proximal and distal ends 104, 106 is facilitated by first and second handles 138, 140.

Massage device 100 will be understood to include suitable electrical circuitry (not shown) electrically connecting battery 112 and electrically powered vibrator 114 to a suitable switch (not shown) for controlling electrically powered vibrator 114. The switch may be mounted to second section 134 of liquid resistant housing 110. Alternatively, the switch may be contained within first chamber 124, where second section 134 of housing 110 is sufficiently flexible to enable actuation of the switch through the second section 134.

Considering the overall configuration of massage device 100, as seen in FIG. 1, elongated strap 102 may be relatively narrow at proximal end 104 and at distal end 106, and relatively wide at massager 108. Massager 108 may be equidistant from proximal end 104 and distal end 106 of elongated strap 102. When incorporating these characteristics, massage device 100 is easily grasped wielded, with massager 108 effectively held against the skin of user 2.

Massage device 100 may further comprise a first strip 144 of hook and loop material between first handle 138 and massager 108, and a complementing second strip 146 of hook and loop material between massager 108 and second handle 140. Massage device 100 may be secured in a compact configuration (not shown, but coiled for example) for stowage.

FIG. 3 shows an optional feature wherein massager 108 is a duplex massager including a first massager 108A including liquid resistant housing 110, battery 112 within liquid resistant housing 110, electrically powered vibrator 114 within liquid resistant housing 110, oscillatable mass 116 within liquid resistant housing 110, and spring coupling 118 between and coupled to oscillatable mass 116 and electrically powered vibrator 114, and a second massager 108B including liquid resistant housing 110, battery 112 within liquid resistant housing 110, electrically powered vibrator 114 within liquid resistant housing 110, an oscillatable mass 116 within liquid resistant housing 110, and spring coupling 118 between and coupled to oscillatable mass 116 and electrically powered vibrator 114. First massager 108A and second massager 108B are located in series along a length of elongated strap 102. Provision of two massagers 108A, 108B may prove more satisfactory where it is desired to stimulate more of the skin than can be stimulated by only one massager 108 (as shown in FIG. 1).

It should be understood that the various examples of the apparatus(es) disclosed herein may include any of the components, features, and functionalities of any of the other examples of the apparatus(es) disclosed herein in any feasible combination, and all of such possibilities are intended to be within the spirit and scope of the present disclosure. Many modifications of examples set forth herein will come to mind to one skilled in the art to which the present disclosure pertains having the benefit of the teachings presented in the foregoing descriptions and the associated drawings.

Therefore, it is to be understood that the present disclosure is not to be limited to the specific examples presented and that modifications and other examples are intended to be included within the scope of the appended claims. Moreover, although the foregoing description and the associated drawings describe examples of the present disclosure in the context of certain illustrative combinations of elements and/or functions, it should be appreciated that different combinations of elements and/or functions may be provided by alternative implementations without departing from the scope of the appended claims.

I claim:

1. A massage device for enabling a user to massage his or her body, the massage device comprising:
an elongated strap including a proximal end and a distal end; and
a massager coupled to the elongated strap, the massager including a liquid resistant housing, a battery within the liquid resistant housing, an electrically powered vibrator within the liquid resistant housing, an oscillatable mass within the liquid resistant housing, and a spring coupling between and coupled to the oscillatable mass and the electrically powered vibrator.

2. The massage device of claim 1, wherein the massager is equidistant from the proximal end and the distal end of the elongated strap.

3. The massage device of claim 1, further comprising at least a first handle at the proximal end of the elongated strap.

4. The massage device of claim 3, wherein the first handle is configured as a closed loop.

5. The massage device of claim 3, further comprising a second handle at the distal end of the elongated strap.

6. The massage device of claim 5, wherein the second handle is configured as a closed loop.

7. The massage device of claim 1, wherein the elongated strap is relatively narrow at the proximal end and at the distal end, and relatively wide at the massager.

8. The massage device of claim 1, wherein the massager is a duplex massager including:
a first massager including a liquid resistant housing, a battery within the liquid resistant housing, an electrically powered vibrator within the liquid resistant housing, an oscillatable mass within the liquid resistant housing, and a spring coupling between and coupled to the oscillatable mass and the electrically powered vibrator; and
a second massager including a liquid resistant housing, a battery within the liquid resistant housing, an electrically powered vibrator within the liquid resistant housing, an oscillatable mass within the liquid resistant housing, and a spring coupling between and coupled to the oscillatable mass and the electrically powered vibrator, wherein
the first massager and the second massager are located in series along a length of the elongated strap.

9. The massage device of claim 1, wherein the liquid resistant housing comprises a flexible section covering the oscillatable mass.

10. The massage device of claim 9, wherein the flexible section of the liquid resistant housing contains therein a fluent gel material and solid beads.

11. The massage device of claim 1, further comprising a plate dividing the liquid resistant housing into a first chamber containing the battery and the vibrator, and a second chamber containing the oscillatable mass.

12. The massage device of claim 11, wherein:
the liquid resistant housing comprises the flexible section and a second section, wherein the second section covers the first chamber; and
the massager comprises at least one fastener removably fastening the second section in a position covering the first chamber.

13. The massage device of claim 1, further comprising a first strip of hook and loop material between the first handle and the massager and a complementing second strip of hook and loop material between the massager and the second handle, whereby the massage device may be secured in a compact configuration for stowage.
